(19) United States
(12) Patent Application Publication
(10) Pub. No.: US 2007/0243741 A1
(43) Pub. Date: Oct. 18, 2007

(54) Plug/unplug moudle base

(76) Inventor: Haven Yang, Sinjhuang City (TW)

Correspondence Address: Dykema Gossett, PLLC;Suite 300 West, 1300 I Street, N.W., Washington, DC, 20005-3306, US

(21) Appl. No.: 11/405,547

(22) Filed: Apr. 18, 2006

(51) Int. Cl. H01R 13/62

(52) U.S. Cl. 439/304

(57) ABSTRACT

The present invention discloses a plug/unplug module base capable of installing its elastic components independently. The plug/unplug module base of the invention comes with independent elastic components and features a more powerful, durable and elastic design of the elastic components, and the manufacturing process of the elastic components can be simplified to lower its cost.

### FIELD OF THE INVENTION

The present invention relates to a plug/unplug module base, and more particularly to a plug/unplug module base capable of installing its elastic components independently.

### BACKGROUND OF THE INVENTION

Since present industries rely on the use of a large quantity of electronic devices, and most electronic devices are connected by plug/unplug devices. Referring to FIGS. 1 to 4 for the exploded view, the perspective view, the side view and the schematic view of a traditional plug/unplug module base according to the present invention respectively, the traditional plug/unplug module base comprises: an upper casing 11, two guiding plates 13, a lower chassis plate 12 and a plastic core 14. The upper casing 11 is a rectangular solid having an opening 111, and the guiding plate 13 includes an elastic component 131 at an end of the guiding plate 13 and a latch hole 132 at the other end of the guiding plate 13, and the plastic core 14 includes two plug/unplug grooves 141. The two guiding plates 13 are installed in the upper casing 11, and the lower chassis plate 12 seals a portion of a longer side of the opening 111 to produce two plug/unplug channels 15 and two plug/unplug openings 16. An end of plug/unplug channel 15 includes the elastic component 131 of the guiding plate 13 and the other end of the plug/unplug channel 15 includes the plug/unplug opening 16 and the latch hole 132 of the guiding plate 13, and the plastic core 14 is disposed in the plug/unplug channel 15 and at an end of the elastic component. When a plug/unplug module 2 is plugged, the plug/unplug module 2 enters into the plug/unplug channel 15 from the plug/unplug opening 16, so that a circuit board 211 of a plug/unplug terminal 21 included in the plug/unplug module 2 is plugged into the plug/unplug groove 141 of the plastic core 14, and the plug/unplug end 21 compresses the elastic component 131 and stores a resilience, and a latch button 22 of the plug/unplug module 2 is latched into the latch hole 132 of the plug/unplug channel 15, such that the plug/unplug module 2 is fixed into the plug/unplug channel 15. When the plug/unplug module 2 is unplugged, the latch hole 132 releases the latch button 22, and the elastic component 131 releases the resilience to push the plug/unplug terminal 21 of the plug/unplug module 2 and further push out the plug/unplug module 2 accordingly.

Since the traditional elastic component 131 needs to avoid the space from being occupied by the plastic core 14, therefore the size of the elastic component 131 has to be very small, the resilience provided by the elastic component 131 is little, and the strength is low. As a result, the elastic component will become elastically exhausted or damaged easily. Further, the small elastic component 131 installed on the guiding plate 13 not only makes the manufacturing procedure more complicated, but also incurs a higher cost.

Thus, finding a way of producing a plug/unplug module base that makes the manufacturing of the elastic component simple and easily and provides a durable and powerful elastic component is an object of this invention.

### SUMMARY OF THE INVENTION

In view of the shortcoming of the traditional plug/unplug module base, the inventor of the present invention based on years of experience in the related industry to conduct extensive researches and experiments, and finally invented a plug/unplug module base in hope of making the manufacturing process of the elastic component simple and easy and providing a durable and powerful elastic component.

Therefore, it is a primary objective of the present invention to provide a plug/unplug module base capable of installing its elastic components independently, making the manufacturing process of the elastic component simple and easy, and providing a durable and powerful elastic component to overcome the prior art.

To achieve the foregoing objective, the present invention provides a plug/unplug module base comprising: at least one plug/unplug channel and a plug/unplug opening interconnected to the plug/unplug channel; a base disposed at an end of the plug/unplug channel without the plug/unplug opening and having at least one plug/unplug groove, such that when a plug/unplug module enters into the plug/unplug channel, the plug/unplug groove can accommodate a portion or the whole of an plug/unplug terminal of the plug/unplug module; at least one elastic component installed at the base, and when the elastic component at the plug/unplug terminal is contained in the plug/unplug groove, the elastic component is in contact with the plug/unplug module and stores a resilience. Thus, such arrangement makes the manufacturing of the elastic component simple and easy and provides a durable and powerful elastic component.

### BRIEF DESCRIPTION OF THE DRAWINGS

FIG. 1 is an exploded view of a traditional plug/unplug module base;

FIG. 2 is a perspective view of a traditional plug/unplug module base;

FIG. 3 is a side view of plugging a plug/unplug module into a traditional plug/unplug module base;

FIG. 4 is a side view of unplugging a plug/unplug module from a traditional plug/unplug module base;

FIG. 5 is an exploded view of a plastic core and an elastic component according to a preferred embodiment of the invention;

FIG. 6 is a perspective view of a plastic core and an elastic component according to a preferred embodiment of the invention;

FIG. 7 is an exploded view of a preferred embodiment of the present invention;

FIG. 8 is a perspective view of a preferred embodiment of the present invention;

FIG. 9 is a side view of plugging a plug/unplug module according to a preferred embodiment of the present invention;

FIG. 10 is a top view of plugging a plug/unplug module according to a preferred embodiment of the present invention; and

FIG. 11 is a top view of unplugging a plug/unplug module according to a preferred embodiment of the present invention.

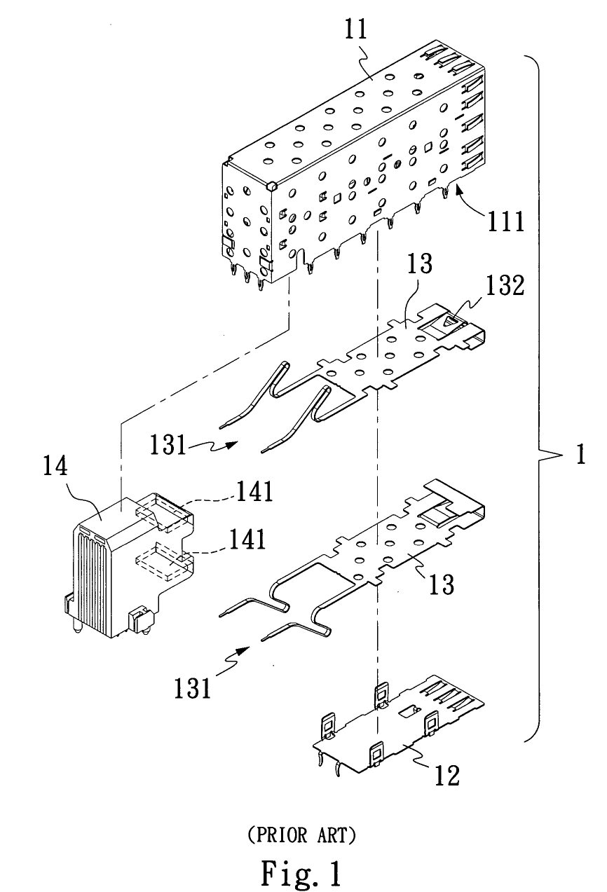

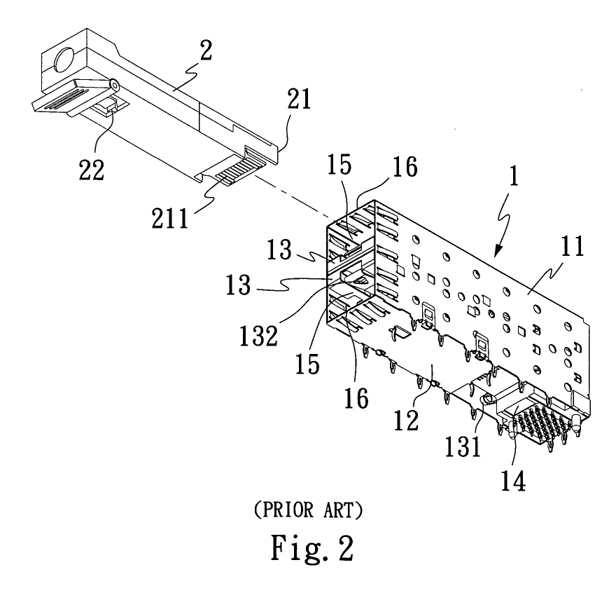

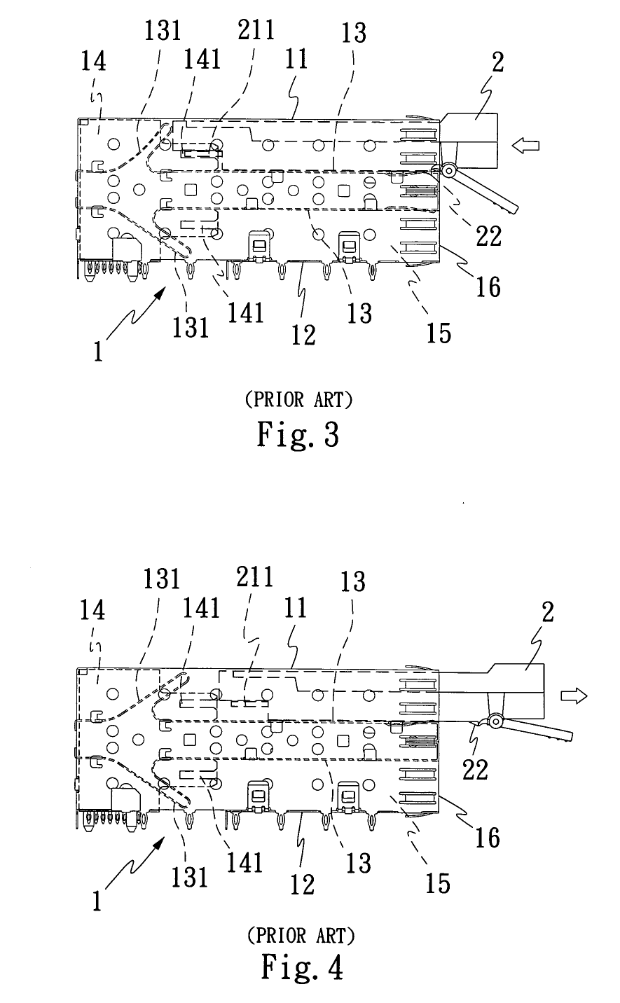

### DETAILED DESCRIPTION OF THE PREFERRED EMBODIMENTS

To make it easier for our examiner to understand the objective, features, and performance of the present invention, we use a preferred embodiment together with the attached drawings for the detailed description of the invention.

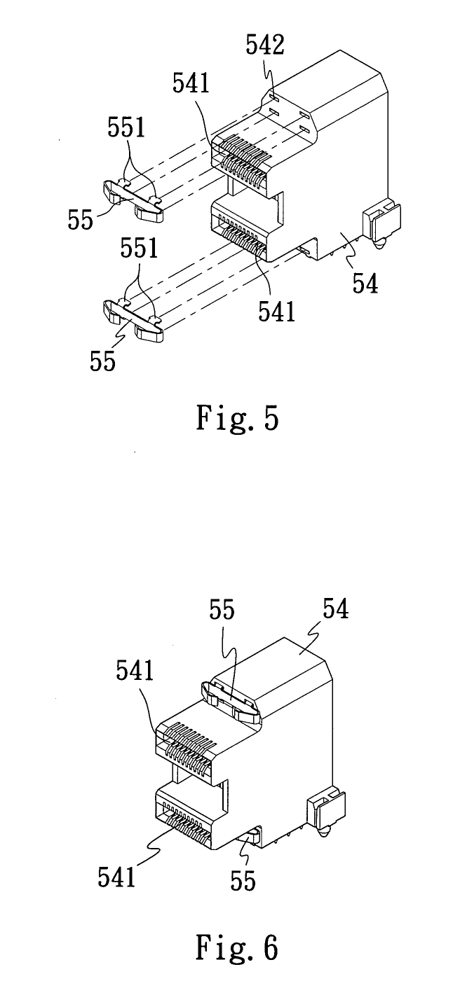

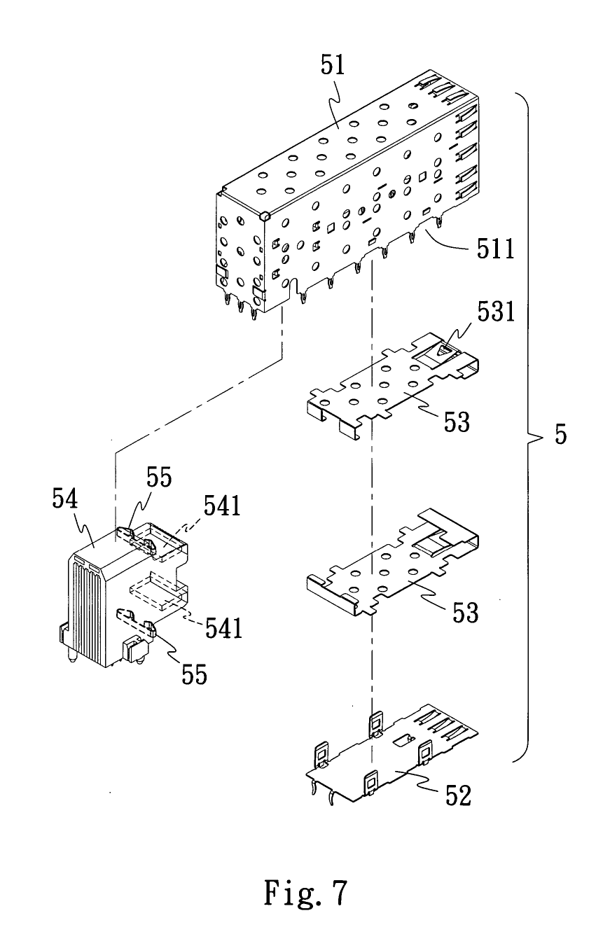

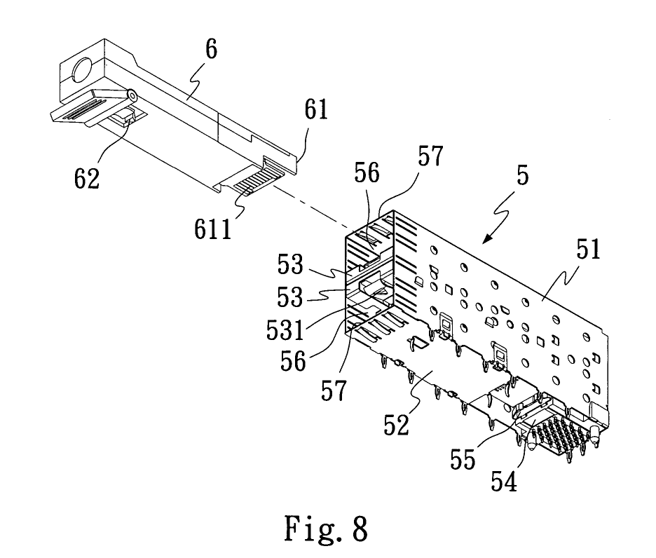

Referring to FIGS. 5 to 8 for the exploded view and the perspective view of a plastic core and an elastic component, and the exploded view and the perspective view of a preferred embodiment of the invention respectively, a plug/unplug module base of the invention comprises: an upper casing 51, two guiding plates 53, a lower chassis plate 52, a base 54 and two elastic components 55, wherein the base 54 could be a plastic core. The upper casing 51 is a rectangular solid having an opening 511, and an end of the guiding plate 53 has a latch hole 531, and the plastic core 54 has two plug/unplug grooves 541 and eight fixing grooves 542, and the elastic component 55 has four fixing buttons 551. The plug/unplug module base 5 is installed in the upper casing 51 by two guiding plates 53, and the lower chassis plate 52 seals a portion of the longer side of the opening 511, such that the plug/unplug module base 5 has two plug/unplug channels 56 and two plug/unplug openings 57 (the plug/unplug module base 5 could comprise a lower chassis for sealing a portion of the longer side of the opening 511 of the upper casing 5, such that the plug/unplug module base 5 has a plug/unplug channel 56 and a plug/unplug opening 57). An end of the plug/unplug channel 56 has a plug/unplug opening 57 and a latch hole 531 of the guiding plate 53, and the base 54 is disposed in the plug/unplug channel 56 and at an end corresponding to corresponding to the plug/unplug opening 57, and a plug/unplug groove 541 of the base 54 corresponds to a plug/unplug terminal 61 of the plug/unplug module 6. Four fixing buttons 551 of the two elastic components 55 are inserted and fixed into four fixing grooves 542 (or fixing holes) of the base 54 respectively (or adhered to a fixed position by an adhesive), and the elastic component 55 corresponds to the plug/unplug terminal 61 of the plug/unplug module 6.

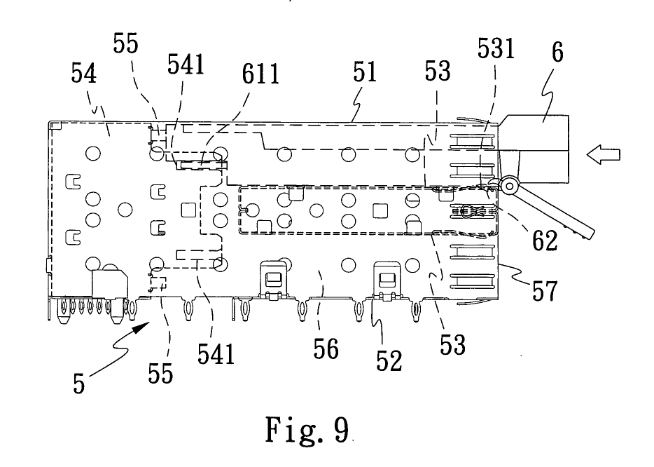

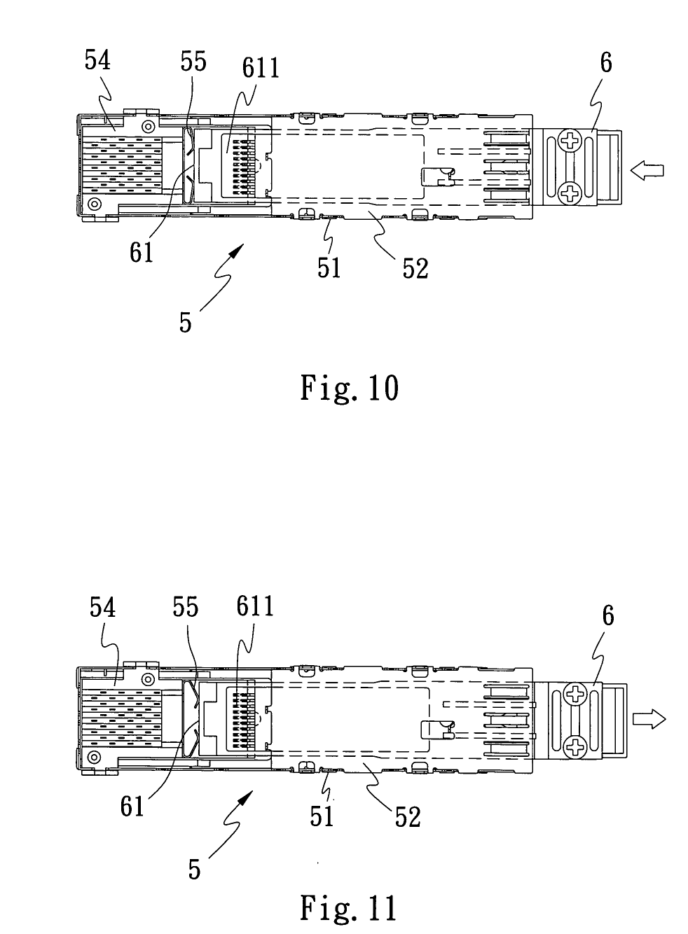

Refer to FIGS. 9 to 11 for the side view of a plug/unplug module, the top view of plugging a plug/unplug module and the top view of unplugging a plug/unplug module according to a preferred embodiment of the present invention respectively. When the plug/unplug module 6 is plugged, the plug/unplug module 6 enters into the plug/unplug channel 56 through the plug/unplug opening 57, so that a circuit board 611 of the plug/unplug terminal 61 included in the plug/unplug module 6 (or the whole plug/unplug terminal 61) is plugged into the plug/unplug groove 541 of the base 54, and the plug/unplug terminal 61 compresses the elastic component 55 and stores a resilience, and the latch button 42 of the plug/unplug module 6 is latched into the latch hole 531 at the plug/unplug channel 56, so that the plug/unplug module 6 is fixed into the plug/unplug channel 56. When the plug/unplug module 6 is unplugged, the latch hole 531 releases the latch button 62, and the elastic component 55 releases the resilience and pushes the plug/unplug terminal 61 of the plug/unplug module 6 and further pushes the plug/unplug module 6 accordingly. Since the elastic component 55 is installed independently and not limited by the space of the base 54, therefore a more powerful, more durable and larger elastic component 55 can be produced.

In summation of the description above, the present invention herein enhances the performance over the conventional structure by providing an independent elastic component, and a simple and easy manufacture of the elastic component, so as to provide a durable and powerful elastic component, and thus the present invention can comply with the patent application requirements and the products produced according to the present invention can meet the current market requirements.

What is claimed is:

1. A plug/unplug module base, comprising:
at least one plug/unplug channel and a plug/unplug opening interconnected to said plug/unplug channel, for allowing a plug/unplug module to enter into said plug/unplug channel from said plug/unplug opening;
a base, disposed in said plug/unplug channel and at an end of said plug/unplug channel without said plug/unplug opening, and having at least one plug/unplug groove, such that when said plug/unplug module enters into said plug/unplug channel, said plug/unplug groove can receive a portion or the whole of a plug/unplug terminal of said plug/unplug module; and
at least one elastic component, installed at said base, such that when said elastic component at said plug/unplug terminal is accommodated in said plug/unplug groove, said elastic component is in contact with said plug/unplug module and stores a resilience.

2. The plug/unplug module base of claim 1, further comprising an upper casing and a lower chassis plate, and said upper casing includes an opening, and said lower chassis plate is installed at a portion of said opening to form said plug/unplug opening and said plug/unplug channel.

3. The plug/unplug module base of claim 1, further comprising an upper casing, at least one guiding plate and a lower chassis plate, and said upper casing includes an opening, and said guiding plate is installed in said upper casing, and said lower chassis plate is installed at a portion of said opening to form said plug/unplug opening and said plug/unplug channel.

4. The plug/unplug module base of claim 1, wherein said plug/unplug channel includes at least one latch hole for latching at least one latch button of said plug/unplug module.

5. The plug/unplug module base of claim 1, wherein said base is a plastic core.

6. The plug/unplug module base of claim 1, wherein said elastic button is fixed to a fixed position either by fixing at least one fixing button installed at said elastic component to at least one fixing groove or at least one fixing, or by using an adhesive.
